(19) United States
(12) Patent Application Publication
(10) Pub. No.: US 2006/0077881 A1
(43) Pub. Date: Apr. 13, 2006

(54) Optical recording medium and optical disc processor for recording information on the optical recording medium

(75) Inventors: Yasumasa Igi, Daito-shi (JP); Hironori Tani, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/226,303

(22) Filed: Sep. 15, 2005

(30) Foreign Application Priority Data
Sep. 15, 2004 (JP) 2004-267712

(51) Int. Cl. G11B 7/24

(52) U.S. Cl. 369/275.1; 369/283

(57) ABSTRACT

An optical recording medium comprises a base layer, recording layers formed on the base layer so that pits, which cause light reflection different from that of areas around the pits, are formed thereon, encoded data pits formed on each of the recording layers in an arrangement corresponding to encoded data produced by encoding information, and visual information-display pits formed on each of the recording layers to have a width larger than that of other pits so as to display visible information. The recording layers are stacked on one side of the base layer. The visual information-display pits are formed in corresponding areas on the respective recording layers. This configuration can produce clearer transitions between light and dark on the optical disc so that the visible information can be displayed to be easily viewable as compared with a conventional configuration where visual information-display pits are formed on only a single recording layer.

### BACKGROUND OF THE INVENTION

1. Field of the Invention

The present invention relates to an optical recording medium such as e.g. an optical disc on which information is recorded in the form of pits which cause light reflection different from that caused by areas around the pits on the optical disc, and to an optical disc processor that records information on an optical disc by forming pits on the disc.

2. Description of the Related Art

It is known to form many pits, having a width larger than that of other pits, on an optical disc to be closely aggregated together in a given pattern so as to produce transitions between light and dark in e.g. figures and characters on the surface of the optical disc, thereby making the information made of the figures and characters visible to the naked eye for display (refer to e.g. Japanese Laid-open Patent Publication Hei 11-213455). This is based on the phenomenon that the intensity of light reflected from the surface of the optical disc with the pits becomes weaker as the pit width becomes larger. The optical disc disclosed in Japanese Laid-open Patent Publication Hei 11-213455 is a single layer disc having only one recording layer and has visual information-display pits for display of visible information that are formed to have a width larger than that of encoded data pits for recording information as encoded data. The visual information-display pits have the same length as the encoded data pits to also serve as encoded data pits.

Other techniques for display of visible information on an optical disc have been also proposed. For example, Japanese Laid-open Patent Publication 2004-171605 discloses an optical disc configured to display visible information made of e.g. figures and characters on the surface of the disc by forming pits of the same length at regular intervals in a given pattern area, based on the phenomenon that the same length pits repeatedly formed at regular intervals cause optical interference. Japanese Laid-open Patent Publication 2003-323746 also discloses an optical disc configured to display visible information made of e.g. figures and characters on the surface of the disc by varying the widths of pits to cause optical interference. The optical disc disclosed in Japanese Laid-open Patent Publication 2004-171605 is a singly layer disc having only one recording layer, wherein visual information-display pits are formed in free space at the outer region of the disc where no encoded data pit is formed. The optical disc disclosed in Japanese Laid-open Patent Publication 2003-323746 is a single layer disc having only one recording layer like the optical disc disclosed in Japanese Laid-open Patent Publication 2004-171605, but it has visual information-display pits that also serve as encoded data pits.

However, the conventional technique as disclosed in Japanese Laid-open Patent Publication Hei 11-213455 has the following problem. Since there is a limit on the width of a pit that can be formed on the optical disc, the transitions between light and dark, which are produced on the surface of the optical disc with the visual information-display pits, are not clear enough to make the visible information easily viewable on the surface of the optical disc. This problem cannot be solved even with the techniques disclosed in Japanese Laid-open Patent Publication 2004-171605 and Japanese Laid-open Patent Publication 2003-323746.

### SUMMARY OF THE INVENTION

An object of the present invention is to provide an optical recording medium and an optical disc processor that allow transitions between light and dark in e.g. figures and characters based on visual information-display pits to be clearly produced on the surface of the optical recording medium, so that visible information can be displayed to be easily viewable.

According to a first aspect of the present invention, this object is achieved by an optical recording medium comprising: a base layer; recording layers formed on the base layer so that pits, which cause light reflection different from that caused by areas around the pits on the optical recording medium, are formed thereon; encoded data pits formed on each of the recording layers in an arrangement corresponding to encoded data produced by encoding information; and visual information-display pits formed on each of the recording layers to have a width larger than that of other pits so as to display visible information.

Therein, multiple ones of the recording layers are stacked on one side of the base layer, and wherein the visual information-display pits are formed in corresponding areas on the respective recording layers.

According to the first aspect of the present invention, the visual information-display pits are formed in corresponding areas on the respective recording layers. This configuration can produce clearer transitions between light and dark as compared with the conventional configuration where visual information-display pits are formed on only the single recording layer. As a result, visible information can be displayed to be more easily viewable and thus avoided from being mistaken. Accordingly, when information specific to each optical recording medium is displayed as the visible information, the optical recording medium can be identified by a user quickly and appropriately. Further, when information about the content recorded as encoded data on each optical recording medium is displayed as the visible information, what information is recorded on the optical recording medium can be seen by a user quickly and appropriately.

Preferably, the visual information-display pits also serve as the encoded data pits. With this configuration, since visible information is recorded in combination with information recorded as encoded data, it can be displayed without decreasing the recording density of information as encoded data.

According to a second aspect of the present invention, the above object is achieved by an optical disc processor for recording information on an optical disc, comprising: an optical disc drive unit for rotating the optical disc having recording layers each of which has recording tracks concentrically or spirally formed thereon; an optical head for irradiating light onto the recording tracks of the optical disc so as to form, on the recording tracks, pits which cause light reflection different from that caused by areas around the pits on the optical disc; an optical head moving unit for moving the optical head above the optical disc; and a controller for controlling the optical head moving unit to move the optical head, and further for controlling the optical disc drive unit to rotate the optical disc, and still further for controlling the optical head to irradiate light, so as to form the pits and thereby record information on the optical disc.

Therein, the controller further serves as a visual information recording unit for recording visible information by forming visual information-display pits to be closely aggregated together in a given pattern, the visual information-display pits having a width larger than that of other pits; wherein, the optical disc is of a multi-layer type in which multiple ones of the recording layers are stacked on one side of a base layer of the optical disc; and wherein, the visual information recording unit forms the visual information-display pits in the same pattern in each of corresponding areas on the respective recording layers so as to record the visible information.

According to the second aspect of the present invention, since the visual information-display pits are formed in corresponding areas on the respective recording layers of the optical disc, the visible information recorded on the optical disc can be displayed to more easily viewable with clearer transitions between light and dark as compared with the conventional configuration where visual information-display pits are formed on only the single recording layer. As a result, the visible information can be avoided from being mistaken. Accordingly, when information specific to each optical disc is recorded as the visible information, the optical disc can be identified by a user quickly and appropriately. Further, when information about the content recorded as encoded data on each optical disc is recorded as the visible information, what information is recorded on the optical disc can be seen by a user quickly and appropriately.

According to a third aspect of the present invention, the above object is achieved by an optical disc processor for recording information on an optical disc, comprising: an optical disc drive unit for rotating the optical disc having recording layers each of which has recording tracks concentrically or spirally formed thereon; an optical head for irradiating light onto the recording tracks of the optical disc so as to form, on the recording tracks, pits which cause light reflection different from that caused by areas around the pits on the optical disc; an optical head moving unit for moving the optical head above the optical disc; and a controller for controlling the optical head moving unit to move the optical head, and further for controlling the optical disc drive unit to rotate the optical disc, and still further for controlling the optical head to irradiate light, so as to form the pits and thereby record information on the optical disc.

Therein, the controller further serves: as an encoded data recording unit for recording encoded data by forming encoded data pits in an arrangement corresponding to the encoded data produced by encoding information; and as a visual information recording unit for recording visible information by forming visual information-display pits to be closely aggregated together in a given pattern, the visual information-display pits having a width larger than that of other pits; wherein, the optical disc is of a multi-layer type in which multiple ones of the recording layers are stacked on one side of a base layer of the optical disc; wherein, the controller still further serves as a coordinate calculating unit for calculating position coordinates on the optical disc on which to form the visual information-display pits so as to record the visible information on the optical disc; wherein, the encoded data recording unit forms the encoded data pits in an arrangement corresponding to different encoded data on each of the recording layers of the optical disc so as to record the encoded data; and wherein based on coordinates calculated by the coordinate calculating unit, the visual information recording unit forms the visual information-display pits in the same pattern in each of corresponding areas on the respective recording layers so as to record the visible information, wherein the visual information recording unit forms the visual information-display pits to also serve as the encoded data pits at positions where the visual information-display pits are to be formed in combination with the encoded data pits formed by the encoded data recording unit, and wherein the visual information recording unit forms the visual information-display pits by increasing the spot diameter of collected light emitted from the optical head, and by increasing the intensity of the light emitted from the optical head.

According to the third aspect of the present invention, since the visual information-display pits are formed in corresponding areas on the respective recording layers of the optical disc, the visible information recorded on the optical disc can be displayed to more easily viewable with clearer transitions between light and dark as compared with the conventional configuration where visual information-display pits are formed on only the single recording layer. As a result, the visible information can be avoided from being mistaken. Accordingly, when information specific to each optical disc is recorded as the visible information, the optical disc can be identified by a user quickly and appropriately. Further, when information about the content recorded as encoded data on each optical disc is recorded as the visible information, what information is recorded on the optical disc can be seen by a user quickly and appropriately. Further, at the positions where the encoded data pits as well as the visual information-display pits are required, the visual information-display pits that also serve as the encoded data pits are formed so that visible information is recorded in combination with information of encoded data. Accordingly, the visible information can be recorded without decreasing the recording density of information recorded as encoded data. Furthermore, since different information of encoded data is recorded on each of the recording layers of the optical disc, the visible information can be recorded without decreasing the recording density of information recorded as encoded data.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1A is a schematic plan view of an optical disc according to one embodiment of the present invention, FIG. 1B is a partially enlarged view of FIG. 1A, and FIG. 1C is a cross sectional view taken along the line A-A of FIG. 1A;

FIG. 2 is a schematic plan view of a part of the optical disc showing an example of pits formed on the optical disc;

FIG. 3 is a schematic plan view of a part of another example of an optical disc according to the present invention;

FIG. 4 is a block diagram schematically showing the configuration of an optical disc processor according to an embodiment of the present invention; and

FIG. 5 is a flow chart showing a recording operation of recording visible information in the optical disc processor.

### DESCRIPTION OF THE PREFERRED EMBODIMENTS

Embodiments of the present invention, as best mode for carrying out the invention, will be described hereinafter. It is to be understood that the embodiments described herein are not intended as limiting, or encompassing the entire scope of, the invention.

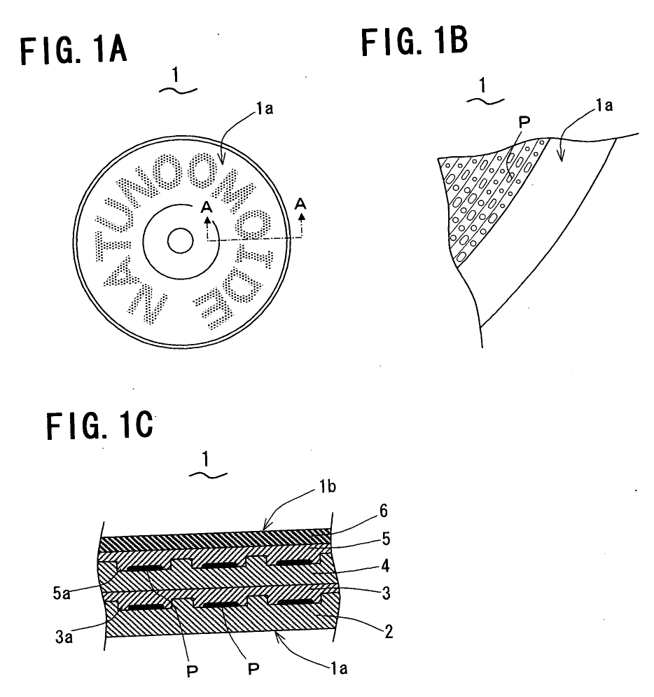

Referring now to the accompanying drawings, an optical recording medium and an optical disc processor that embody the present invention are described. FIGS. 1A, 1B, and 1C are schematic views showing an optical disc 1 that is an optical recording medium according to the present invention. The optical disc 1 has, on its information recording surface 1a, information such as e.g. video and music encoded and recorded in the form of pits P which cause light reflection different from that caused by areas around the pits on the disc. The optical disc 1 also has information visible to the naked eye such as figures and characters formed by producing transitions between light and dark based on variations of reflection intensities caused by the pits P (an example of the information shown in FIG. 1A is “NATUNOOMOIDE”).

The optical disc 1 comprises a base layer 2, a first recording layer 3, a spacer layer 4, a second recording layer 5, and a protective layer 6, and is a dual layer disc in which the first recording layer 3 and the second recording layer 5 are stacked on one side of the base layer 2.

The base layer 2 is transparent, and the first recording layer 3 is formed on the base layer 2. The first recording layer 3 is also transparent, and has recording tracks 3a concentrically or spirally formed at a given pitch. The recording tracks 3a have thereon pits P which cause light reflection different from that of areas around the pits. The spacer layer 4 is also transparent, and the second recording layer 5 is formed on the spacer layer 4 which in turn is formed on the first recording layer 3. Like the first recording layer 3, the second recording layer 5 has recording tracks 5a that are concentrically or spirally formed at a given pitch and have pits P thereon. The protective layer 6 is formed on the second recording layer 5.

A surface of the base layer 2 is the information recording surface 1a. The optical disc processor described later detects the lengths and arrangement of the pits P to read the encoded data by irradiating light onto the information recording surface 1a (from the side of the base layer 2), whereby the information such as video and music is reproduced. The pitch for the recording tracks 3a is the same as that for the recording tracks 5a, so that the recording tracks 3a and 5a are aligned in the direction perpendicular to the information recording surface 1a. A surface of the protective layer 6 is a label surface 1b. Information indicating e.g. content recorded on the optical disc 1 is described on the label surface 1b by e.g. printing. The visible information based on the variations of reflection intensities caused by the pits P is displayed on the information recording surface 1a (on the base layer 2 side).

The information such as video and music is recorded by forming pits P to have lengths and arrangement corresponding to encoded data produced by encoding the information. The visible information based on the variations of reflection intensities caused by pits P is recorded by forming pits P having a width larger than other pits to be closely aggregated together in a given display pattern area, based on the phenomenon that the intensity of light reflected from the surface of the optical disc with the pits becomes weaker as the pit width becomes larger.

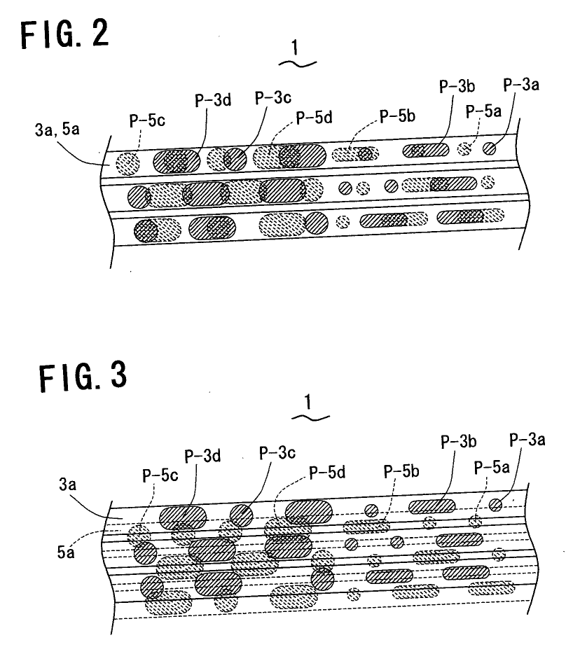

FIG. 2 shows an example of pits P formed on the optical disc 1. Pits P-3a, P-3b, P-3c, and P-3d are formed on the recording tracks 3a of the first recording layer 3. Pits P-5a, P-5b, P-5c, and P-5d are formed on the recording tracks 5a of the second recording layer 5.

The pits P-3a, P-3b, P-5a, and P-5b are encoded data pits for recording information such as video and music, and are formed to have lengths and arrangement corresponding to encoded data produced by encoding the information. On the other hand, the pits P-3c, P-3d, P-5c, and P-5d are visual information-display pits for recording visible information, and are formed to have a width larger than the pits P-3a, P-3b, P-5a, and P-5b.

Many visual information-display pits P-3c and P-3d are formed to be closely aggregated together in a given display pattern area on the first recording layer 3, and many visual information-display pits P-5c and P-5d are formed to be closely aggregated together in an area on the second recording layer 5 that corresponds to the display pattern area on the first recording layer 3.

Since many visual information-display pits P-3c, P-3d, P-5c, and P-5d having the larger width are formed to be closely aggregated together in the given display pattern area, the light reflection in the display pattern area is reduced so as to produce transitions between light and dark on the information recording surface 1a of the optical disc 1 that correspond to the display pattern. Thereby, e.g. figures and characters (“NATUNOOMOIDE” in the example shown in FIG. 1A) that correspond to the display pattern are displayed as visible information on the information recording surface 1a of the optical disc 1. Visible information recorded by forming visual information-display pits includes e.g. information specific to the optical disc 1 and information indicating the content recorded on the optical disc 1 as encoded data.

The visual information-display pits P-3c, P-3d, P-5c, and P-5d are formed to have lengths and arrangement corresponding to encoded data produced by encoding information like the encoded data pits P-3a, P-3b, P-5a, and P-5b so that the visual information-display pits can also serve as encoded data pits. In other words, the optical disc 1 has information of encoded data and visible information recorded thereon in combination. Further, the encoded data pits P-3a and P-3b and the visual information-display pits P-3c and P-3d on the first recording layer 3 are formed in an arrangement corresponding to encoded data different from that for the encoded data pits P-5a and P-5b and the visual information-display pits P-5c and P-5d on the second recording layer 5. More particularly, different information of encoded data is recorded on each of the first and second recording layers 3 and 5.

The encoded data pits P-3a, P-3b, P-5a, and p-5b and the visual information-display pits P-3c, P-3d, P-5c, and P-5d are formed by e.g. irradiating light onto the optical disc 1 having the first and second recording layers 3 and 5 that are writable while adjusting the spot diameter of collected light and the intensity of the irradiated light. More particularly, the spot diameter of collected light and the intensity of irradiated light are made normal for formation of the encoded data pits P-3a, P-3b, P-5a, and P-5b while the spot diameter of collected light is made larger and the intensity of irradiated light is made higher for formation of the visual information-display pits P-3c, P-3d, P-5c, and P-5d.

It is also possible to form the encoded data pits P-3a, P-3b, P-5a, and P-5b and the visual information-display pits P-3c, P-3d, P-5c, and P-5d by pressing a metal mold having projections and depressions that correspond to the pits against the first and second recording layers 3 and 5 when laying on the base layer 2 the first recording layer 3, the spacer layer 4, the second recording layer 5, and the protective layer 6 in turn to produce the optical disc 1.

According to the optical disc 1 described above, the visual information-display pits P-3c and P-3d, and P-5c and P-5d are formed in corresponding areas on the first and second recording layers 3 and 5. Accordingly, the visual information-display pits P-3c and P-3d on the first recording layer 3 and the visual information-display pits P-5c and P-5d on the second recording layer 5 overlap each other or the total area of the visual information-display pits P-3c, P-3d, P-5c, and P-5d becomes large, whereby transitions between light and dark can be clear on the optical disc.

The above described configuration can produce clearer transitions between light and dark so that visible information can be displayed to be more easily viewable, as compared with the conventional configuration where visual information-display pits are formed on only a single recording layer. This can avoid visible information from being mistaken. Accordingly, when information specific to the optical disc 1 is displayed as the visible information, the optical disc 1 can be identified by a user quickly and appropriately. Further, when information about the content recorded as encoded data on the optical disc 1 is displayed as the visible information, what information is recorded on the optical disc 1 can be seen quickly and appropriately.

Further, the visual information-display pits P-3c, P-3d, P-5c, and P-5d also serve as encoded data pits. In other words, visible information is recorded in combination with information of encoded data. Accordingly, the visible information can be displayed without decreasing the recording density of information recorded as encoded data. Moreover, the encoded data pits P-3a and P-3b and the visual information-display pits P-3c and P-3d on the first recording layer 3 are formed in an arrangement corresponding to encoded data different from that for the encoded data pits P-5a and P-5b and the visual information-display pits P-5c and P-5d on the second recording layer 5. This also allows display of visible information without decreasing the recording density of information as encoded data.

FIG. 3 shows the configuration of another example of an optical disc 1 according to the present invention. The optical disc 1 shown in FIG. 3 has recording tracks 3a and recording tracks 5a that are formed to be at the same pitch but staggered by one-half of the pitch relative to each other. According to this optical disc 1, visual information-display pits P-3c and P-3d on the recording tracks 3a and visual information-display pits P-5c and P-5d on the recording tracks 5a partially overlap each other or the total area of the visual information-display pits P-3c, P-3d, P-5c, and P-5d becomes large, whereby transitions between light and dark on the optical disc can be made clear. Accordingly, the above described optical disc 1 can also produce clearer transitions between light and dark so that visible information can be displayed to be more easily viewable as compared with the conventional configuration where visual information-display pits are formed on only a single recording layer.

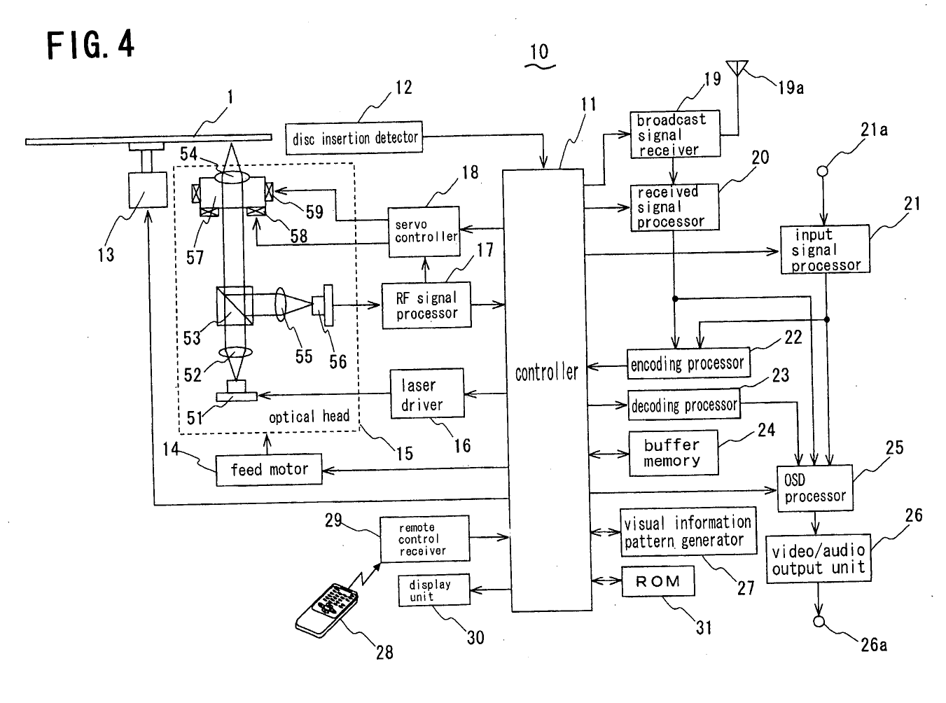

FIG. 4 shows the configuration of the optical disc processor 10 embodying the present invention. The optical disc processor 10 is a device that forms pits P causing light reflection different from that of areas around the pits on the optical disc 1 so as to record coded information such as e.g. video and music on the optical disc 1, and further detects the pits P formed on the optical disc 1 so as to reproduce the information recorded on the optical disc 1. The optical disc processor 10 is designed to be operable by a user to record, on the optical disc 1, information which is visible to the naked eye based on variations of reflection intensities caused by the pits P as described above (an example of the information shown in FIG. 1 is “NATUNOOMOIDE”).

The optical disc processor 10 comprises: a controller 11 including a CPU (Central Processor Unit) for controlling the optical disc processor 10. As will be clear from later descriptions, the controller 11, by itself or with other elements, serves: as an encoded data recording unit for recording encoded data by forming encoded data pits in an arrangement corresponding to the encoded data produced by encoding information; as a visual information recording unit for recording visible information by forming visual information-display pits to be closely aggregated together in a given pattern, the visual information-display pits having a width larger than that of other pits; as a coordinate calculating unit for calculating position coordinates on the optical disc 1 on which to form the visual information-display pits so as to record the visible information on the optical disc 1; and as other units.

The optical disc processor 10 further comprises: a disc insertion detector 12; a spindle motor 13; a feed motor 14; an optical head 15; a laser driver 16; an RF (Radio Frequency) signal processor 17; a servo controller 18; a broadcast signal receiver 19; a received signal processor 20; an input signal processor 21; an encoding processor 22; a decoding processor 23; a buffer memory 24; an OSD (On Screen Display) processor 25; a video/audio output unit 26; a visual information pattern generator 27; a remote control 28; a remote control receiver 29; a display unit 30; and a ROM (Read Only Memory) 31. The disc insertion detector 12 detects that the optical disc 1 has been inserted into a disc insertion slot (not shown), and inputs the detection signal to the controller 11. The optical disc 1 inserted into the disc insertion slot is mounted on the spindle motor 13. The spindle motor 13 is rotated under the control of the controller 11 so as to rotate the mounted optical disc 1. These elements, including the spindle motor 13, for rotating the optical disc 1 constitute an optical disc drive unit. The feed motor 14 comprises a linear motor, and moves the optical head 15 above the optical disc 1 in a radial direction of the optical disc 1. The feed motor 14, with other elements in case of need for moving the optical head 15 above the optical disc 1, constitutes an optical head moving unit.

For recording information of the coded data and the visible information on the optical disc 1, the optical head 15 irradiates light onto the optical disc 1 so as to form pits P to cause light reflection different from that around the pits P. Further, for reading the information of the coded data recorded on the optical disc 1, the optical head 15 irradiates light onto the optical disc 1 so as to detect the pits P formed on the optical disc 1. The optical head 15 comprises a semiconductor laser 51, a collimating lens 52, a beam splitter 53, an objective lens 54, a collecting lens 55 and a light receiving element 56.

The semiconductor laser 51 is driven by the laser driver 16 to emit light. The light emitted from the semiconductor laser 51 is collected and irradiated onto the optical disc 1 through the collimating lens 52, beam splitter 53, and objective lens 54. Light reflected from the optical disc 1 is collected onto the light receiving element 56 through the objective lens 54, beam splitter 53 and collecting lens 55. The objective lens 54 is held by a lens holder 57, and is moved in a direction perpendicular to the surface of the optical disc 1 and in a radial direction of the optical disc 1 by the magnetic force of a focusing coil 58 and a tracking coil 59 under the control of the servo controller 18. The movement of the objective lens 54 is used to adjust the position of the collecting point and the spot diameter of the collected light, which is originally emitted from the semiconductor laser 51 and thereafter collected and irradiated onto the optical disc 1. The light receiving surface of the light receiving element 56 is divided into multiple areas. The multiple areas of the light receiving element 56 respectively output electric signals according to the light intensities received thereby.

The optical head 15 irradiates light emitted from the semiconductor laser 51 onto the information recording surface 1a of the optical disc 1, and thereby changes the properties of the first and second recording layers 3 and 5 of the optical disc 1, so as to form pits P. Furthermore, the optical head 15 irradiates light emitted from the semiconductor laser 51 onto the information recording surface 1a of the optical disc 1 in order for the light receiving element 56 to receive light reflected from the optical disc 1, so as to detect the pits P formed on the optical disc 1. For detecting the pits P, the intensity of the light emitted from the semiconductor laser 51 is weakened so as to prevent the property change of the first and second recording layers 3 and 5 of the optical disc 1.

The laser driver 16 controls emission timing and emission intensity of the semiconductor laser 51 under the control of the controller 11. Based on output signals from the light receiving element 56, the RF signal processor 17 generates and outputs an RF signal (reflection intensity signal), a focusing error signal and a tracking error signal. Based on the focusing error signal and the tracking error signal from the RF signal processor 17, the servo controller 18 drives the focusing coil 58 and the tracking coil 59, and thereby moves the objective lens 54 so as to control the position of the collecting point of the light emitted from the semiconductor laser 51 and irradiated onto the optical disc 1.

Under the control of the controller 11, the receiving frequency of the broadcast signal receiver 19 is tuned to a frequency of a television broadcast signal transmitted from a broadcast station so as to receive the television broadcast signal via an antenna 19a. Under the control of the controller 11, the received signal processor 20 demodulates the television broadcast signal received by the broadcast signal receiver 19 so as to generate video and audio signals. Furthermore, under the control of the controller 11, the input signal processor 21 processes signals input via a signal input terminal 21a from external devices such as a video camera and a digital camera, so as to generate video and audio signals.

Under the control of the controller 11, the encoding processor 22 receives the video and audio signals generated by and output from the received signal processor 20 and the input signal processor 21, and generates encoded data of these video and audio signals that are encoded in a given format. The buffer memory 24 temporarily stores the encoded data to be recorded on the optical disc 1, and also stores encoded data read from the optical disc 1.

For recording the encoded data on the optical disc 1, the optical head 15 forms, under the control of the controller 11, pits P on the optical disc 1 that are encoded data pits representing the encoded data by lengths and arrangement of the pits. On the other hand, for reading the encoded data from the optical disc 1, the optical head 15 detects the pits P recorded on the optical disc 1, and the RF signal processor 17 outputs RF signals based on the data detected by the optical head 15. The controller 11 discriminates the lengths and the arrangement of the pits P on the basis of the output RF signals, whereby the encoded data is read from the optical disc 1.

Under the control of the controller 11, the decoding processor 23 decodes the encoded data read from the optical disc 1 so as to generate video and audio signals. The OSD processor 25 superimposes various on-screen display signals on the video signals under the control of the controller 11. The video/audio output unit 26 outputs video and audio signals to a display, a speaker, and so on through a signal output terminal 26a under the control of the controller 11.

The visual information pattern generator 27 generates a display pattern of visible information to be recorded on the optical disc 1. The visible information is recorded on the optical disc 1 in a manner that many visual information-display pits P, which have a width larger than that of other pits P, are formed on the optical disc 1 so as to be closely aggregated together in a given display pattern area. The visual information pattern generator 27 generates the display pattern based on visual information-creating data input from the controller 11. Based on the display pattern generated by the visual information pattern generator 27 and on address data of the optical disc 1, the controller 11 calculates position coordinates on the optical disc 1 on which to form the visual information-display pits.

The remote control 28 is operated by a user to command the optical disc processor 10 for various operations including: selection of a channel to receive; recording/reproduction of information based on encoded data of e.g. video and audio; and recording of visible information. Thus, the remote control 28 has various operation keys (detailed description omitted) to be operated by the user. When the user operates the various operation keys, the remote control 28 sends out coded infrared signals which are made to correspond to the operations.

The remote control receiver 29 receives infrared signals sent out from the remote control 28, and converts the received infrared signals to electric signals, and further outputs, to the controller 11, the signals corresponding to the operations of the remote control 28. The display unit 30 is provided on a front panel of a main body of the optical disc processor 10 so as to display contents of the operations by the remote control 28, operational states of the optical disc processor 10, and so on. The ROM 31 stores operation programs of the controller 11.

The controller 11 determines the contents of the operations by the remote control 28 based on the output signals from the remote control receiver 29, and controls various operations including an operation of receiving television broadcast signals, an operation of recording, on the optical disc 1, video and audio of television programs transmitted with the television broadcast signals, an operation of recording, on the optical disc 1, video and audio input from e.g. a video camera or a digital camera, an operation of reproducing video and audio recorded on the optical disc 1, and an operation of recording visible information on the optical disc 1.

For recording video and audio of a television program on the optical disc 1, the received signal processor 20 generates, under the control of the controller 11, video and audio signals based on the television broadcast signals received by the broadcast signal receiver 19. The controller 11 controls the encoding processor 22 to encode the video and audio signals, and records the encoded data on the optical disc 1. On the other hand, for recording video and audio input from e.g. a video camera or a digital camera on the optical disc 1, the input signal processor 21 generates, under the control of the controller 11, video and audio signals based on signals input from the signal input terminal 21a. The controller 11 controls the encoding processor 22 to encode the video and audio signals, and records the encoded data on the optical disc 1.

For recording the encoded data, encoded data pits representing the encoded data by lengths and arrangement of the pits are formed as pits P on the optical disc 1. Depending on available space on the optical disc 1, the encoded data pits are formed on the recording tracks 3a or 5a of the first or second recording layer 3 or 5 in order from the inner side of the tracks, so that different information of encoded data is recorded on each of the first and second recording layers 3 and 5.

When recording the video and audio on the optical disc 1, a TOC (Table of Contents) including title information indicating the contents of the recorded video and audio is recorded, under the control of the controller 11, in a read-in area of the optical disc 1 in the format of encoded data. In the case of recording video and audio of a television program, the title information is acquired from electronic program information contained in the television broadcast signal. On the other hand, in the case of recording video and audio input from e.g. the video camera or the digital camera, the title information is either acquired from the input signals or automatically added.

For reproducing video and audio recorded on the optical disc 1, pits formed on the optical disc 1 are detected under the control of the controller 11 so as to read encoded data recorded on the optical disc 1. The controller 11 controls the decoding processor 23 to decode the encoded data, and outputs video and audio signals obtained by the decoding from the video/audio output unit 26.

For recording visible information on the optical disc 1, many visual information-display pits P, which have a width larger than that of other pits P, are formed on the optical disc 1 so as to be closely aggregated together in a display pattern indicating the title information contained in the TOC recorded (or to be recorded) on the optical disc 1. The visual information-display pits are formed on the respective recording tracks 3a and 5a of the first and second recording layers 3 and 5 of the optical disc 1.

The controller 11 calculates position coordinates on the optical disc 1 on which to form the visual information-display pits as follows. Under the control of the controller 11, title information contained in the TOC recorded (or to be recorded) on the optical disc 1 is read, and is used as visual information-creating data by the visual information pattern generator 27 to generate a display pattern indicating visible information (here the display pattern indicates the title information). Based on the display pattern and the address data of the optical disc 1, the controller 11 calculates the position coordinates.

The visual information-display pits are formed in a manner that the objective lens 54 of the optical head 15 is moved to increase the spot diameter of the collected light emitted from the optical head 15, and that the emission output of the semiconductor laser 51 is increased to increase the intensity of the light emitted from the optical head 15. The controller 11 controls the feed motor 14 to move the optical head 15, and further controls the spindle motor 13 to rotate the optical disc 1, and still further controls the optical head 15 to irradiate light so as to form pits P (encoded data pits and/or visual information-display pits) on the optical disc 1, thereby recording the encoded data and/or the visible information, and so as to detect the pits P on the optical disc 1, thereby reading the encoded data.

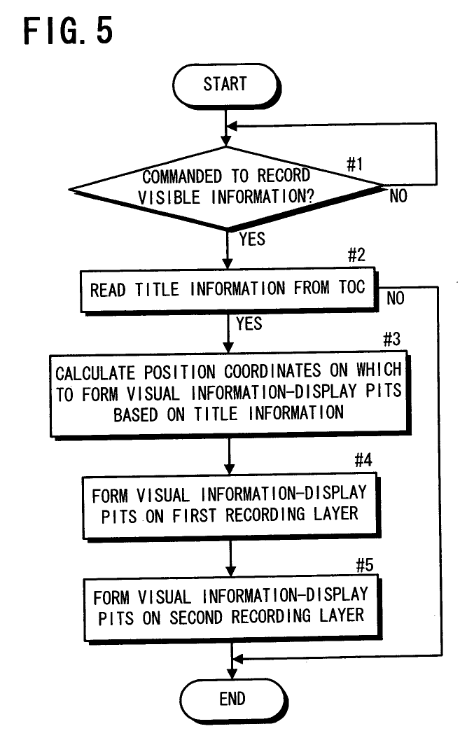

FIG. 5 is a flow chart showing a recording operation of recording visible information in the optical disc processor 10. It is to be noted that the recording operation shown in this flow chart is performed in the case where the optical disc 1 is a rewritable dual layer DVD (Digital Versatile Disc). When commanded by the remote control 28 to record visible information (YES in #1), the controller 11 reads title information contained in the TOC recorded on the optical disc 1 (#2), and calculates position coordinates on the optical disc 1 on which to form visual information-display pits on the basis of the title information (#3). Note that if the controller 11 finds no video or audio recorded on the optical disc 1, and no title information recorded in the TOC in the above step #2, then the controller 11 displays e.g. an error message, and ends the recording operation of recording the visible information.

Subsequently, the controller 11 forms visual information-display pits at positions on the first recording layer 3 of the optical disc 1 that correspond to the calculated coordinates (#4). In this step, when encoded data pits have been already formed at the positions on the first recording layer 3 where the visual information-display pits are to be formed, the encoded data pits are re-formed into visual information-display pits of the same length as the encoded data pits (i.e., into visual information-display pits that also serve as encoded data pits).

Subsequently, the controller 11 forms visual information-display pits at positions on the second recording layer 5 of the optical disc 1 that correspond to the coordinates calculated in the above step #3 (#5). In this step, when encoded data pits have been already formed at the positions on the second recording layer 5 where the visual information-display pits are to be formed, the encoded data pits are re-formed into visual information-display pits of the same length as the encoded data pits (i.e., into visual information-display pits that also serve as encoded data pits). Thereby, visible information is recorded on the optical disc 1.

When the optical disc 1 is a dual layer DVD that allows recording only once, it is possible to record visible information at the same time when information such as video and music is recorded on the optical disc 1. More particularly, position coordinates on which to form visual information-display pits can be calculated in advance based on title information, which is acquired when information such as video and music is recorded on the optical disc 1, before encoded data pits representing encoded data produced by encoding information such as video and music are formed in order on the first or second recording layer 3 or 5 of the optical disc 1. While the encoded data pits are formed, visual information-display pits that also serve as encoded data pits are formed at positions where the visual information-display pits should be formed.

According to the optical disc processor 10 described above, visual information-display pits are formed in corresponding areas on the first and second recording layers 3 and 5 of the optical disc 1. This allows transitions between light and dark in e.g. figures and characters based on the visual information-display pits to be clearly displayed on the optical disc 1, as compared with the conventional configuration where visual information-display pits are formed on only a single recording layer. Accordingly, the optical disc processor 10 described above can provide the optical disc 1 on which visible information is displayed to be more easily viewable.

Further, the visual information-display pits are formed to also serve as encoded data pits, so that visible information is recorded to be combined with information of encoded data. Accordingly, the visible information can be recorded without decreasing the recording density of information recorded as encoded data. Moreover, different information of encoded data is recorded on each of the first and second recording layers 3 and 5. This also allows visible information to be recorded without decreasing the recording density of information of encoded data.

It is to be noted that the present invention is not limited to the above-described specific embodiments, and various modifications are possible. For example, the optical disc 1 can have visual information-display pits not serving as encoded data pits. In this case, the visual information-display pits can be formed, for example, at a given outermost area of the optical disc 1 that is assigned as an area for recording visible information. In addition, the information to be recorded by using encoded data pits can be information other than video or music.

In the above described embodiment, the optical disc processor 10 reads title information recorded on the optical disc 1 to record the title information as visible information, but it can be configured to record, as visible information, e.g. characters and symbols input by operating the remote control 28. Further, the optical disc processor 10 can be configured so as to record visible information on an optical disc not containing information such as video and music.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2004-267712 filed Sep. 15, 2004, the contents of which are hereby incorporated by reference.

What is claimed is:

1. An optical recording medium comprising:
a base layer;
recording layers formed on the base layer so that pits, which cause light reflection different from that caused by areas around the pits on the optical recording medium, are formed thereon;
encoded data pits formed on each of the recording layers in an arrangement corresponding to encoded data produced by encoding information; and
visual information-display pits formed on each of the recording layers to have a width larger than that of other pits so as to display visible information,
wherein multiple ones of the recording layers are stacked on one side of the base layer; and
wherein the visual information-display pits are formed in corresponding areas on the respective recording layers.

2. The optical recording medium according to claim 1, wherein the visual information-display pits also serve as the encoded data pits.

3. An optical disc processor for recording information on an optical disc, comprising:
an optical disc drive unit for rotating the optical disc having recording layers each of which has recording tracks concentrically or spirally formed thereon;
an optical head for irradiating light onto the recording tracks of the optical disc so as to form, on the recording tracks, pits which cause light reflection different from that caused by areas around the pits on the optical disc;
an optical head moving unit for moving the optical head above the optical disc; and
a controller for controlling the optical head moving unit to move the optical head, and further for controlling the optical disc drive unit to rotate the optical disc, and still further for controlling the optical head to irradiate light, so as to form the pits and thereby record information on the optical disc,
wherein the controller further serves as a visual information recording unit for recording visible information by forming visual information-display pits to be closely aggregated together in a given pattern, the visual information-display pits having a width larger than that of other pits;
wherein the optical disc is of a multi-layer type in which multiple ones of the recording layers are stacked on one side of a base layer of the optical disc; and
wherein the visual information recording unit forms the visual information-display pits in the same pattern in each of corresponding areas on the respective recording layers so as to record the visible information.

4. An optical disc processor for recording information on an optical disc, comprising:
an optical disc drive unit for rotating the optical disc having recording layers each of which has recording tracks concentrically or spirally formed thereon;
an optical head for irradiating light onto the recording tracks of the optical disc so as to form, on the recording tracks, pits which cause light reflection different from that caused by areas around the pits on the optical disc;
an optical head moving unit for moving the optical head above the optical disc; and
a controller for controlling the optical head moving unit to move the optical head, and further for controlling the optical disc drive unit to rotate the optical disc, and still further for controlling the optical head to irradiate light, so as to form the pits and thereby record information on the optical disc,
wherein the controller further serves: as an encoded data recording unit for recording encoded data by forming encoded data pits in an arrangement corresponding to the encoded data produced by encoding information; and as a visual information recording unit for recording visible information by forming visual information-display pits to be closely aggregated together in a given pattern, the visual information-display pits having a width larger than that of other pits;
wherein the optical disc is of a multi-layer type in which multiple ones of the recording layers are stacked on one side of a base layer of the optical disc;
wherein the controller still further serves as a coordinate calculating unit for calculating position coordinates on the optical disc on which to form the visual information-display pits so as to record the visible information on the optical disc;
wherein the encoded data recording unit forms the encoded data pits in an arrangement corresponding to different encoded data on each of the recording layers of the optical disc so as to record the encoded data; and
wherein based on coordinates calculated by the coordinate calculating unit, the visual information recording unit forms the visual information-display pits in the same pattern in each of corresponding areas on the respective recording layers so as to record the visible information, wherein the visual information recording unit forms the visual information-display pits to also serve as the encoded data pits at positions where the visual information-display pits are to be formed in combination with the encoded data pits formed by the encoded data recording unit, and wherein the visual information recording unit forms the visual information-display pits by increasing the spot diameter of collected light emitted from the optical head, and by increasing the intensity of the light emitted from the optical head.
